(19) United States
(12) Patent Application Publication
(10) Pub. No.: US 2021/0067739 A1
(43) Pub. Date: Mar. 4, 2021

(54) SYSTEMS AND METHODS OF USING A BLOCKCHAIN TO SECURE A BUILDING MANAGEMENT SYSTEM

(71) Applicant: Honeywell International Inc., Morris Plains, NJ (US)

(72) Inventors: Deepak Sundar Meganathan, Bangalore (IN); RajeshBabu Nalukurthy, Bangalore (IN); Srivatsa Haridas, Bangalore (IN); Leehm Tang, Shanghai (CN); Zhanka Xue, Shanghai (CN); Kun Liu, Shanghai (CN)

(21) Appl. No.: 16/558,895

(22) Filed: Sep. 3, 2019

(51) Int. Cl. H04N 7/18; H04L 9/06

(52) U.S. Cl. CPC H04N 7/181; H04L 2209/38; H04L 9/0643; H04L 9/0637

(57) ABSTRACT

A building management system having one or more layers of security. The building management system may include building management devices and building management clients configured to be used to access the one or more building management devices. The building management devices and the building management clients may be in communication with one another to form a blockchain network. Individual building management devices and individual building management clients may each be a blockchain node of the blockchain network. In some cases, the building management system may include user accounts through which users access data on the building automation system. The user accounts may be a blockchain node of the blockchain network formed by the building automation system.

### TECHNICAL FIELD

This disclosure relates generally to computing and network security. More specifically, this disclosure relates to systems and methods for using blockchains to secure building management systems having components connected by or in communication via one or more computing networks.

### BACKGROUND

Building management systems (BAS) are routinely used to monitor, control, and automate building controls, which may include security systems, surveillance systems, environment control systems, etc. An increasing level of security defense mechanisms have been needed as these systems have evolved from closed proprietary systems to convenient, connected, and open systems over the years. Open systems were adopted in a trend shift for increased convenience, improved connectivity, and improved productivity. However, these systems have become more vulnerable to exploits due to the widespread knowledge about open system vulnerabilities. Among other things, industrial facilities have used public-key infrastructures along with digital certificates to help increased security in their industrial control systems. However, improved techniques to help secure industrial control systems such as building management systems would be desirable.

### SUMMARY

This disclosure is directed towards computing and network security, and more particularly to systems and methods for using blockchains to help secure building management systems having components connected by or in communication on one or more computing networks.

In one example, a building management system may include one or more building management devices and one or more building management clients. The building management clients may be configured to be used by a user to access the one or more building management devices. At least one of the one or more building management devices and/or at least one of the one or more building management clients may each be a blockchain node of a blockchain network for the building management system

In another example, a surveillance system may include a video recorder and a storage device. The storage device may be in communication with the video recorder to receive and store data from the video recorder. The video recorder and the storage device may each be a blockchain node in a private network for the surveillance system.

In yet another example, a method may be utilized for operating a blockchain network of a building management system, where the blockchain network includes a plurality of blockchain nodes. The method may include recording data with a data recorder. The data recorder may be a first blockchain node of the blockchain network. A cryptographic signature may be assigned to the data recorded at the data recorder and the cryptographic signature assigned to the data recorded at the data recorder may be sent to each blockchain node of the blockchain network.

The preceding summary is provided to facilitate an understanding of some of the features of the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following detailed description of various embodiments in connection with the accompanying drawings, in which:

FIG. 1 is a schematic diagram of an illustrative building management system;

FIG. 2 is a schematic diagram of an illustrative computing device;

FIG. 3 is a schematic diagram of an illustrative blockchain;

FIG. 4 is a schematic diagram of an illustrative blockchain network for a building management system;

FIG. 5 is a schematic diagram of an illustrative blockchain network;

FIG. 6 is a schematic flow diagram of an illustrative method of operating a building automation system; and

FIG. 7 is a schematic flow diagram of an illustrative method of operating a building automation system.

While the disclosure is amenable to various modifications and alternative forms, specifics thereof have been shown by way of example in the drawings and will be described in detail. It should be understood, however, that the intention is not to limit aspects of the disclosure to the particular embodiments described. On the contrary, the intention is to cover all modifications, equivalents, and alternatives falling within the spirit and scope of the disclosure.

### DESCRIPTION

The following detailed description should be read with reference to the drawings in which similar elements in different drawings are numbered the same. The detailed description and the drawings, which are not necessarily to scale, depict illustrative embodiments and are not intended to limit the scope of the disclosure. The illustrative embodiments depicted are intended only as exemplary. Selected features of any illustrative embodiment may be incorporated into an additional embodiment unless clearly stated to the contrary.

Typical building management systems may include surveillance systems, environment control systems, security systems, etc. Typical components of building management systems include, but are not limited to, heating units, air conditioning units (e.g., cooling units), blowers/fans, control panels, dampers, humidifiers, dehumidifiers, thermostats, occupancy sensors, cameras, video recorders (e.g., video cameras, digital video recorders (DVRs), network video recorders (NVRs), video servers, streaming servers, database servers, network communication components, modems, routers, etc. Building management systems may include 10s, 100s, or even 1000s or more of components, where one or more of the components may be internet protocol (IP) enabled (e.g., IP enabled components) that are configured to communicate over one or more public and/or private networks.

As building management systems have components that communicate over one or more public or private networks, it is often desirable for the data produced by the components of the building management system to be secured from unauthorized access. For example, it is often desirable for the integrity and authenticity of live video streams from security cameras and video services, recorded video data, exported video data (e.g., when such data is being used as evidence in a legal proceeding), data modifications, and/or other data of building management systems to be maintained. However, in many building management systems, only a basic server to client user authentication (e.g. user name/password) is used to enable users to view and modify video, logs and/or other data, often without leaving a trace. This is especially problematic when some components of a building management system are installed using default usernames and passwords, which may be publicly known from user manuals or the like, thereby leaving the components largely open to the public domain. This disclosure discusses more robust systems and methods for securing access to data produced by industrial process control systems such as building management systems.

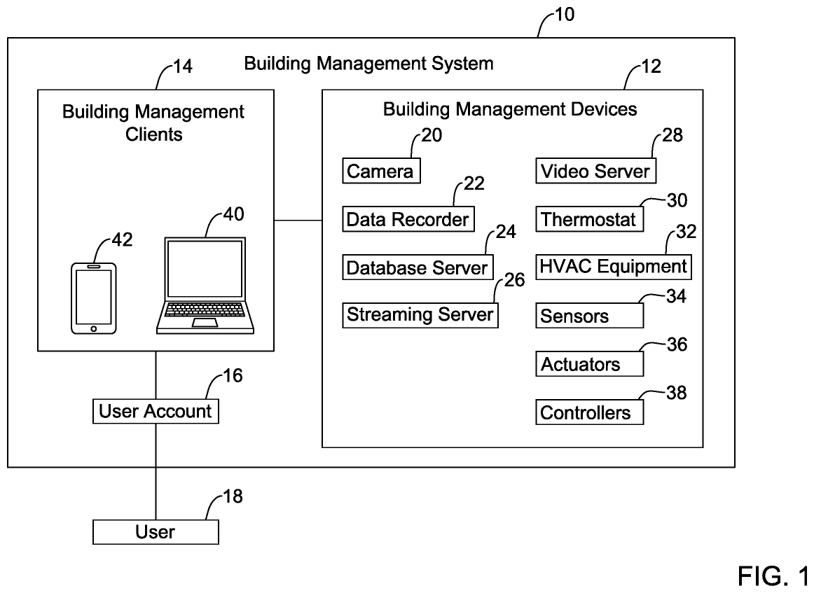

FIG. 1 depicts a schematic block diagram of an illustrative building management system 10 having one or more components including, but not limited to, one or more building management devices 12, one or more building management clients 14, and one or more user accounts 16 through which one or more users 18 may access the building management system 10. In some cases, data related to the one or more user accounts 16 may be stored on a server that may be one or more of the building management devices 12, but this is not required. In some cases, the server(s) storing the one or more user accounts 16 and/or the data related to the one or more user accounts 16 may be separate from the building management devices 12. The building management devices 12, building management clients 14, and/or other suitable components of the building management system 10 may be configured to communicate with one another and/or other computing devices over one or more public and/or private wired and/or wireless networks.

The one or more networks on which the devices 12 of the building management system 10 may communicate may be any suitable type of network that facilitates interaction (e.g., transfer of data, information, actions, requests, and/or other suitable communication) between building management devices 12, the building management clients 14, the user accounts 16, and/or other suitable components of the building management system 10. Example networks include, but are not limited to, an Ethernet network (e.g., one supporting a FOUNDATION FIELDBUS protocol and/or other suitable protocol), an electrical signal network (e.g., a HART network and/or other suitable network), a pneumatic control signal network, and/or other suitable additional or alternative networks. The one or more networks may be or may include a local or private network (e.g., a local area network (LAN)) and/or global or public network (e.g., a wide area network (WAN)).

The building management devices 12 may be any suitable type of device configured to facilitate management of a building. In some cases, at least some of the building management devices 12 may include a computing device having a processor, memory, an input/output (I/O) unit (e.g., which may include a communications unit), and/or other suitable computing components. Example building management devices 12 may include, but are not limited to, cameras 20, data recorders 22, database servers 24, streaming servers 26, video servers 28, thermostats 30, heating, ventilation, and air conditioning (HVAC) equipment 32 (e.g., heating units, cooling units, humidifiers, dehumidifiers, blowers/fans, etc.), sensors 34, actuators 36, controllers 38, and/or other suitable devices. One example building management system 10 may include a surveillance system that has one or more building management devices 12, such as one or more cameras 20, one or more data recorders 22, one or more database servers 24, one or more streaming servers 26, one or more video servers 28, and/or other suitable building management devices.

The building management clients 14 may be any suitable type of device configured to facilitate user access to and/or communication with the building management devices 12. The building management client 14 may include a computing device having a processor, memory, an I/O unit (e.g., which may include a communications unit), and/or other suitable components. In some cases, the building management clients 14 may be or may include one or more of a thick client (e.g., a computing device and associated hardware) and/or a thin client (e.g. web browser). Example thick clients include a personal computer 40, a mobile phone 42, a tablet computer, a laptop computer, a server, etc. Example thin clients may include a web client (e.g., a web-based client having a website interface to communicate with the building management devices 12), a mobile application (app) (e.g., a mobile app having an interface to communicate with the building management system 10), etc. In one example of a building management client 14, the building management client 14 may facilitate the user 18 accessing his/her user account 16 for the building management system 10 by interacting with a user interface of the building management client 14 via a computer program, a website, and/or web-based application.

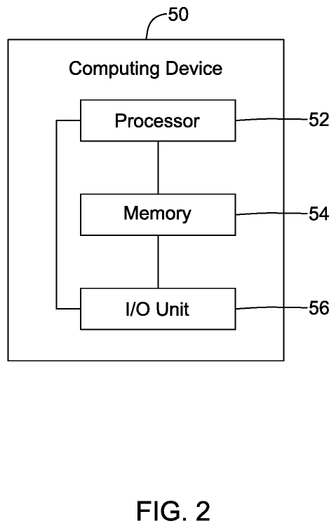

FIG. 2 depicts a schematic block diagram of a computing device 50, the components of which may be incorporated in and/or utilized by the building management devices 12, the building management clients 14, and/or other computing device components discussed herein. The computing device 50 may include, among other suitable components, a processor 52, memory 54, and an I/O unit 56. The processor 52 of the computing device 50 may include a single processor or more than one processor working individually or with one another. The processor 52 may be configured to execute instructions, including instructions that may be loaded into the memory 54 and/or other suitable memory. Example processor components may include, but are not limited to, microprocessors, microcontrollers, multi-core processors, graphical processing units, digital signal processors, application specific integrated circuits (ASICs), field programmable gate arrays (FPGAs), discrete circuitry, and/or other suitable types of data processing devices.

The memory 54 of the computing device 50 may include a single memory component or more than one memory component each working individually or with one another. Example types of memory 54 may include random access memory (RAM), EEPROM, FLASH, suitable volatile storage devices, suitable non-volatile storage devices, persistent memory (e.g., read only memory (ROM), hard drive, Flash memory, optical disc memory, and/or other suitable persistent memory) and/or other suitable types of memory. The memory 54 may be or may include a non-transitory computer readable medium.

The I/O units 56 of the computing device 50 may include a single I/O component or more than one I/O component each working individually or with one another. Example I/O units may be any type of communication port configured to communicate with other components of the respective building management devices 12 and building management clients 14, and/or other components of the building management system 10. Example types of I/O units 56 may include wired ports, wireless ports, radio frequency (RF) ports, Low-Energy Bluetooth ports, Bluetooth ports, Near-Field Communication (NFC) ports, HDMI ports, WiFi ports, Ethernet ports, VGA ports, serial ports, parallel ports, component video ports, S-video ports, composite audio/video ports, DVI ports, USB ports, optical ports, and/or other suitable ports.

Since the building management system 10 may include one or more components connected to one or more networks, it is often desirable for the data of the building management system 10 to be secured from unauthorized access, unauthorized deletion, and/or unauthorized modification. In some case, components of the building management system 10 may require user authentication via a username and password, biometrics, and/or other suitable user identifying techniques. Such security measures on their own, however, may only require a central database to confirm the identity of the user and provide appropriate access. Such security measures may be overcome to allow unauthorized access to and/or manipulation of data by inside threats (e.g., approved users) and/or outside threats (e.g., users that have not been approved for access). In some cases, it would be desirable to provide more robust security measures.

As discussed further below, a blockchain network may be configured from components of the building management system 10 to authenticate users and devices of and/or interacting with the building management system 10 and to secure data of and/or communications with the building management system 10. For example, each of the devices (hardware and/or software), clients (e.g., computing devices and/or software of or interacted with via a computing device that can access devices of the building management system), and users (all users given access to one or more devices of the building management system 10 via a user account or other authentication information) in a network of the building management system 10 may act as a blockchain node of a blockchain network and/or a validator on the blockchain to enforce. This may help preserve the integrity of data and operations of the building management system 10, along with verifying the validity of users (e.g., user accounts and/or requests from users) accessing the building management system 10. The blockchain network may be established using components of the building management system 10 to help secure the building management system 10 from unauthorized access and/or tampering.

A blockchain generally refers to a distributed ledger of transactions, where various parties may have access to the distributed ledger. The parties may use the distributed ledger to perform various functions, such as publishing new transactions to the blockchain or using the blockchain to obtain or verify information. New transactions may be added as blocks to a blockchain using cryptographic operations, and each block in the blockchain (except the first block) may be linked to a previous block in the blockchain. Approval by a threshold number of parties of the blockchain may be needed to add transactions to the blockchain and/or to verify certain information.

Generally speaking, a blockchain network may be or may include a plurality of computing devices linked to each other, without a central computing device, where interactions with and/or of a system (e.g., a building management system, currency system, or other suitable system) may be recorded via transaction tokens or blocks in a distributed ledger (e.g., the blockchain) and distributed to each or set ones of the plurality of computing devices forming the blockchain network. The blockchain network may be publicly accessible so that any public entity may configure their system to secure its data using the public block chain network. Such a blockchain network may be a public blockchain network. Alternatively or additionally, the block chain network may be a private blockchain network that may be proprietary to a single entity or group of entities for securing data associated with one or more systems of the single entity or groups of entities. In a private blockchain network, the block are typically encrypted. In both cases, the transactions and/or other data recorded in the blockchain are often duplicated and distributed across many blockchain host nodes.

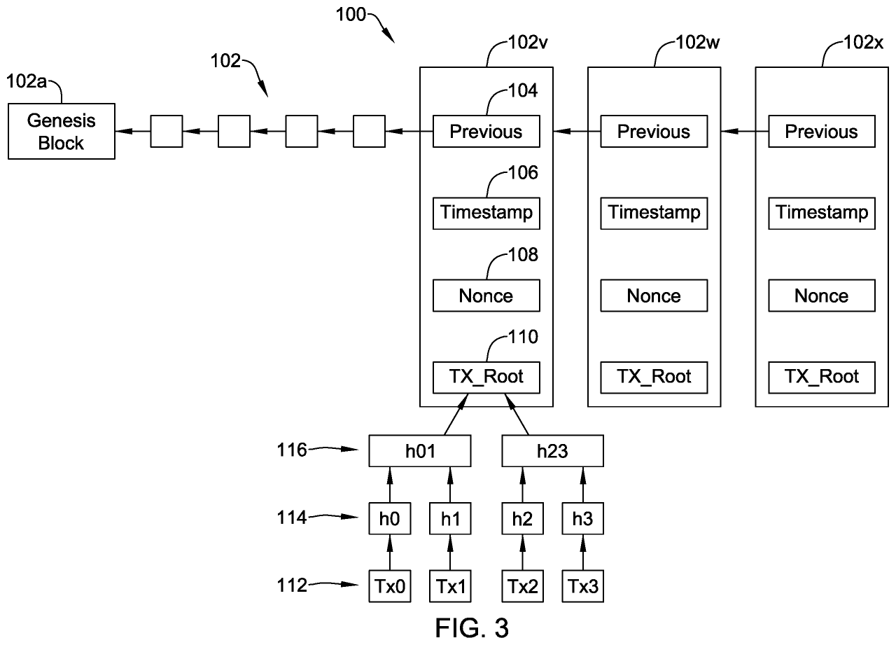

FIG. 3 illustrates an example blockchain 100 (e.g., an example distributed ledger) used to secure data and help ensure the integrity of the data of building management systems or other systems according to this disclosure. As shown in FIG. 3, the blockchain 100 may include a sequence of blocks 102a-102x (which are referred to generally as blocks 102). Each block 102 may function as a record associated with a specific transaction and, in some cases, each block 102 may be considered a transaction token. One or more of the blocks 102 may include or may be associated with one or more smart contracts that define allowable communications between nodes of the blockchain network and/or interactions with the blockchain network. Except for the first block 102a in the blockchain 100, each block 102 may include a previous hash value 104, which may represent a cryptographic hash from the previous block 102 in the blockchain 100. Each block 102 of the blockchain may include a timestamp 106, which identifies the date and time that the associated block 102 was created and a cryptographic signature (e.g., the cryptographic hash and/or other suitable cryptographic signature).

Each block 102 may further include a nonce value 108, which may represent a value that is added to the block 102 by the device (e.g., a building management device 12) that created the block 102. The nonce value 108 may provide proof to other devices that the device that created the block 102 performed certain cryptographic operations in order to generate a valid block 102, where the other devices can easily verify the validity of the block 102 using the nonce value 108.

Each block 102 may include transaction data, which may include a transaction root hash value 110, but the transaction root hash value is not necessarily required. The transaction root hash value 110 in each block 102 may represent a hash value generated by the device that created that block 102 based on transaction information. In one example, the transaction root hash value 110 in each block 102 may be generated by taking data 112 associated with one or more transactions (e.g., smart contract data, user data, user location data, device location data, and/or other suitable data) and applying one or more hashing functions using the data 112. This may generate one or more hash values 114. Assuming there are multiple hash values 114, one or more additional hashing functions (such as pairwise hashing functions) may be applied to the hash values 114 in order to generate one or more additional hash values 116. An additional hashing function may then be applied to the hash values 116 and other contents of the block 102 in order to generate the root hash value 110. Note that this represents one example of how the transaction root hash value 110 may be generated and other examples are contemplated. In general, the root hash value 110 may be generated in any suitable manner, and often the root hash value 110 represents a cryptographic hash of most or all of the block 102. In some cases, the root hash value may be considered a cryptographic signature include with the block 102.

In one aspect of operation, multiple copies of the blockchain 106 may be stored and maintained by multiple host nodes (e.g., where a host node may be a node of a blockchain network containing the distributed ledger (e.g., the blockchain)). In some cases, all nodes of the blockchain network may be host nodes, but this is not required and instead, some number of nodes less than all of the nodes in the blockchain network may be host nodes. The blockchain 106 therefore may function as a distributed ledger that can be used by multiple devices to obtain or verify information contained in the blocks 102 of the blockchain 106.

Devices (e.g., nodes) may “mine” the blockchain 106 to identify blocks 102 containing desired information, such as one or more blocks 102 containing a smart contract involving two or more specific nodes. Devices may also generate new transaction data (such as new smart contracts), and cryptographic operations may be performed using the transaction data to create and add new blocks 102 to the blockchain 106. Thus, new blocks 102 may be appended to the blockchain 106 at different host nodes as new transactions occur, and these blocks 102 may be propagated to other host nodes so that the blockchain 106 can be updated at those nodes. Each new block 102 may be linked to a previous block 102 in the blockchain 106 as described above, which may help prevent someone from illicitly changing data in earlier blocks 102 of the blockchain 106. Approval of a threshold amount of the nodes of the blockchain network may be required before each new block 102 is added to the blockchain 106, before mined information is deemed valid, before a user is authorized, and/or before, a user request is granted.

A threshold amount of nodes may be all nodes or some number fewer than all nodes. For example, the threshold amount of nodes may be one hundred percent (100%) of nodes, ninety-five percent (95%) of nodes, ninety percent (90%) of nodes, eight percent (80%) of nodes, seventy percent (70%) of nodes, sixty percent (60%), fifty percent (50%) of nodes, twenty-five percent (25%) of nodes, and/or other suitable percentage of nodes or number of nodes.

In the context of establishing trust between nodes for communications (e.g., approval of a user to enter the blockchain network and/or approval of a request by a user), a blockchain 100 can be used to identify approved smart contracts involving various nodes of the blockchain network. When a node of the blockchain network attempts to initiate a communication session with another node of the blockchain network, the blockchain 100 may be used to determine whether a smart contract has already been approved for the initiating node. If so, at least one block 102 of the blockchain 100 may be identified as containing an appropriate smart contract, and the communication session may be allowed to proceed. If not, the node receiving the initiating request may generate a smart contract and request approval from one or more other nodes on the blockchain network, and one or more new blocks 102 may be added to the blockchain 100 (whether approved or rejected) that reflects the generated smart contract. Further, the blockchain 100 may be used by applications or other nodes in determining whether the initiating node is trusted, as well.

In this way, the blockchain 100 may provide a tamper-evident distributed ledger that can be used by multiple nodes. This may help establish trust between the various nodes in the blockchain network without relying on third-party digital certificates or self-signed digital certificates. The use of blockchain technology also helps to provide data security and data authenticity. In addition, the use of blockchain technology allows for distributed availability of the data.

Additional features of blockchain technology and additional features of blockchain technology as applied to industrial control systems are found in U.S. patent application Ser. No. 15/970,418, filed on May 3, 2018, and titled APPARATUS AND METHOD FOR USING BLOCKCHAINS TO ESTABLISH TRUST BETWEEN NODES IN INDUSTRIAL CONTROL SYSTEMS OR OTHER SYSTEMS, which is hereby incorporated by reference in its entirety and for all purposes.

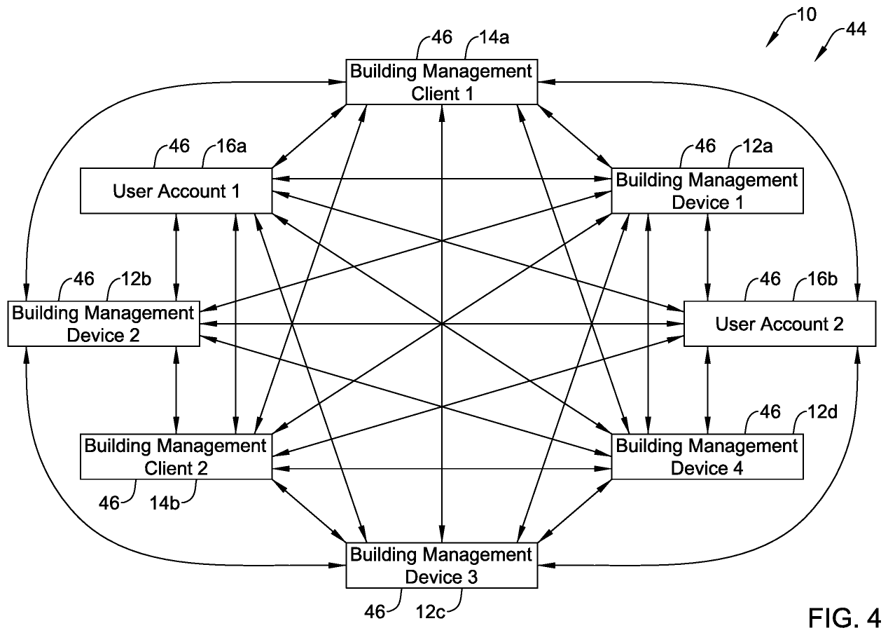

As depicted schematically in FIG. 4, an illustrative blockchain network 44 may be configured from one or more components of the building management system 10. That is, in some cases, computing devices (e.g., a computing device such as the computing device 50 and/or other suitable computing devices) of the building management system 10 and interconnected over a computing network may be nodes 46 of the blockchain network 44 used to secure the building management system 10. The computing devices of the building management system 10 may be programmed to implement the methods and/or techniques of blockchain nodes discussed herein.

FIG. 4 depicts an illustrative blockchain network 44 with the building management devices 12, the building management clients 14, and/or the user accounts 16 of the building management system 10 being utilized as nodes of the blockchain (e.g., nodes of the blockchain 100, discussed above). In the example depicted in FIG. 4, each of a Building Management Device 1 12a, a Building Management Device 2 12b, a Building Management Device 3 12c, a Building Management Device 12d, a Building Management Client 1 14a, a Building Management client 2 14b, a User Account 1 16a, and a User Account 2 16b may be nodes 46 of the blockchain network 44, where each node 46 is configured to communicate with each other node 46 over one or more computing networks. Although four building management devices 12, two building management clients 14, and two user accounts 16 are shown as nodes 46 in the blockchain network 44, nodes 46 of the blockchain network may include any suitable number of computing devices 50 and/or user accounts associated with the building management system 10.

The nodes 46 of the blockchain network 44 depicted in FIG. 4 may be located at a single geographic location (e.g., at a single building, where the building management system 10 may be configured to manage the single building) or at two or more geographic locations (e.g., two or more buildings, where the building management system 10 may be configured to manage the two or more buildings). The blockchain network 44 depicted in FIG. 4 may be a public or a private blockchain network. In some cases, the blockchain network 44 may be a private network and may require authorization of a user before the user can interact with the blockchain network. Such authorization may be a typical username and password required for logging into a user account, may be based on biometric information, may require certain criteria (e.g., a proximity detection, such as being connected to a LAN, an authorized device detection, etc.), and/or may require other information prior to allowing interaction with the blockchain network 44.

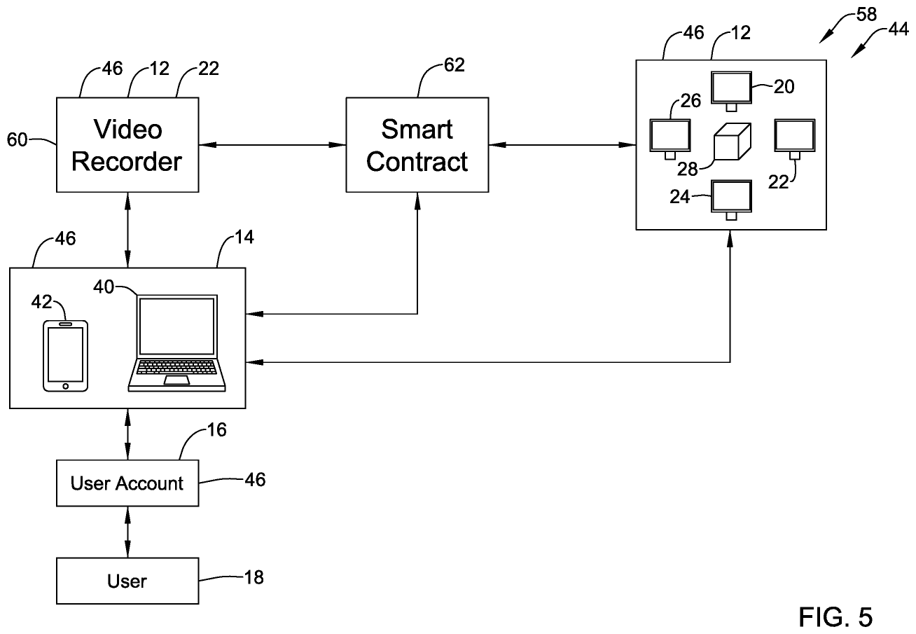

FIG. 5 depicts an illustrative schematic block diagram of the blockchain network 44 having nodes 46 formed from computing devices (e.g., the computing device 50 and/or other suitable computing devices) of a surveillance system 58 of a building management system (e.g., the building management system 10 and/or other suitable building management system). The surveillance system 58 may include one or more building management devices (e.g., the building management devices 12 and/or other suitable building management devices). Example building management devices of the surveillance system 58 may include, but are not limited to, one or more of cameras 20, data recorders 22, database servers 24, streaming servers 26, video servers 28, and/or other suitable computing devices of a surveillance system, all of which or a portion of which may be nodes 46 in the blockchain network 44.

In some cases, data recorded and/or captured by the surveillance system 58 may be stored in the blockchain in any suitable manner. In one instance, a video recorder 60 or other suitable data recorder 22 may capture data and desire to store the data locally and/or to a data storage device (e.g., the database server 24, the streaming server 26, the video server 28, and/or other suitable servers). When the video recorder 60 is desiring to store captured data, the video recorder 60 may identify a smart contract 62 to associate with captured data that is to be stored. The smart contract 62 may indicate under what conditions the captured data may be stored, accessed and/or modified (e.g., the smart contract may provide user rights information).

In one example of associating captured data with a smart contract, the video recorder 60 may identify its address on the blockchain network 44 and identify one or more smart contracts 62 (e.g., in the blockchain of the blockchain network 44) that is associated with the video recorder 60 (e.g., the address of the video recorder 60) and that specifies access terms for data obtained from the video recorder 60. A single smart contract 62 may contain all access rights for the blockchain network 44 or more than one smart contract 62 may be utilized for assigning access rights for the blockchain network 44. Other suitable techniques for selecting a smart contract and/or associating the smart contract with captured data are contemplated. The access terms may provide that certain nodes of the blockchain network 44 have read only access, write only access, read and write access, and/or other suitable terms for accessing the data obtained by the video recorder 60.

Once the data recorded by the video recorder 60 has been associated with the one or more smart contracts 62 defining access rights to the recorded data, the video recorder 60 may send the video data to a data storage device and may send an associated transaction token (e.g., a block of the blockchain) to all of the nodes 46 of the blockchain network 44 maintaining a distributed ledger of transactions for the blockchain network 44. In some cases, the transaction token may include information concerning which video recorder recorded the data, a location at which the data is stored, information concerning the smart contract associated with the video, a cryptographic signature (e.g., a hash value, such as root hash value or other suitable cryptographic signature), meta data, time duration of the recorded data, a timestamp from when the data was recorded, key pictures from the recorded data, and/or one or more other suitable types of information usable to access the stored data.

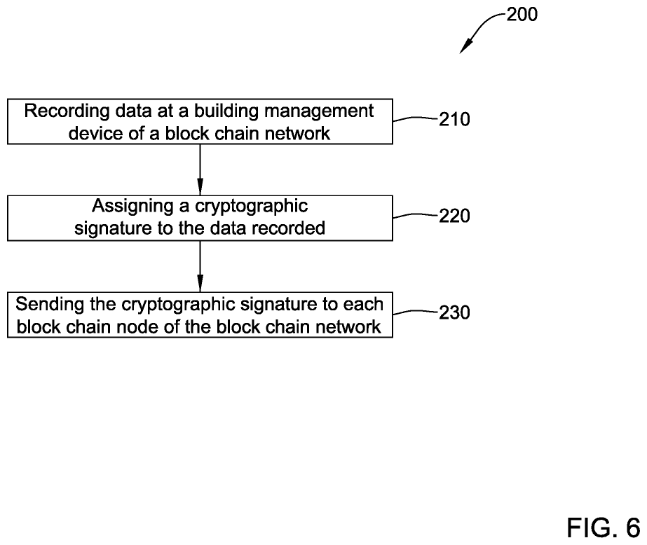

As depicted in FIG. 6, a method 200 of operating a blockchain network (e.g., the blockchain network 44 and/or other suitable blockchain network) of a surveillance system (e.g., the surveillance system 58 and/or other suitable surveillance system) and that has a plurality of blockchain nodes 46 may be utilized. The method 200 may help improve the integrity of surveillance system data and/or information.

Within a surveillance system, data may be recorded 210 at a data recorder (e.g., the video recorder 60 and/or other suitable data recorder), other recorder, and/or otherwise inputted into the surveillance system. In some cases, the data recorder may be a first blockchain node (e.g., the blockchain node 46 and/or other suitable blockchain node), but this is not required.

Once data has been recorded, a cryptographic signature may be assigned 220 to the recorded data. Although not required, the data recorder that records the data may be configured to establish the cryptographic signature and assign the cryptographic signature and a transaction token to the recorded data. The cryptographic signature may be a cryptographic hash and/or other suitable cryptographic signature, as discussed herein.

After assigning the cryptographic signature to the recorded data, the data recorder may send 230 the cryptographic signature assigned to the data recorded at the data recorder to one or more other blockchain nodes of the blockchain network. In some cases, the cryptographic signature may be sent to the one or more of the other nodes via a transaction token assigned by the data recorder, where the assigned transaction token with the cryptographic signature may be stored in the blockchain of the blockchain network. The data recorded may be saved with the transaction token in the blockchain or, alternatively, the cryptographic signature and the location of the saved data may be provided in the transaction token distributed to the nodes of the blockchain network and the data recorded may be saved in a recorded data database (e.g., the database server 24, the streaming server 26, the video server 28, etc.) When a transaction token is included, the transaction token may include, among other information and/or data, information concerning which video recorder recorded the data, a location at which the data is stored, information concerning the smart contract associated with the video, a cryptographic signature (e.g., a hash value, such as root hash value or other suitable cryptographic signature), meta data, time duration of the recorded data, a timestamp from when the data was recorded, key pictures from the recorded data, and/or one or more other suitable types of information usable to access the stored data.

Returning to FIG. 5, the user 18 may desire to access the surveillance system 58 for one or more purposes. In one example, the user 18 may desire to access data of the surveillance system that is being recorded or has been recorded. In such cases, the user 18 may access its user account 16 by entering credentials and/or other suitable information that may or may be utilized to identify the user 18 (e.g., biometric information, username and/or password, a location of the user, etc.) to a building management client 14 (e.g., the mobile phone 42, the personal computer 40, and/or other suitable building management clients). Once the credentials of the user 18 have been entered, the building management client 14 (e.g., a node of the blockchain network 44) may send the credentials to one or more of the nodes 46 for verification. The nodes 46 on the blockchain network 44 may determine whether the entered credentials match credentials of a user account 16 on the blockchain (e.g., the distributed ledger) of the blockchain network 44. If the credentials of the user 18 do match credentials associated with the user account 16, the blockchain network 44 may provide the user 18 access to the blockchain network 44 and determine, via one or more smart contracts 62 or other mechanism, a level of access to the surveillance system 58 for the user account 16. If the credentials of the user 18 do not match the user account 16, the blockchain network 44 may deny access to the surveillance system 58 for the user 18.

In one example, once the user 18 has gained access to the surveillance system 58 or simultaneously with a request for access to the surveillance system 58, the user 18 may request access to data and/or information related to the surveillance system 58. In response to the user making the request for access to data and/or information related to the surveillance system 58, the nodes 46 of the blockchain network 44 may receive the request and may be configured to determine whether a threshold number of nodes approved and/or validated the request. In some cases, determining whether the request is valid may involve the nodes 46 of the blockchain network 44 determining if the request is valid based on the one or more smart contracts 62 associated with the requested data, the video recorder 60 that recorded the data, the user account 16, and the building management client 14 through which the user 18 may access the blockchain network 44. If a threshold number of nodes 46 indicate the request is valid, the request will be approved by the blockchain network 44 and one or more transaction tokens associated with the request and approval may be initiated and entered into the blockchain to record the request. If the threshold number of nodes 46 do not indicate the request is valid, the request will be denied by the blockchain network 44 and one or more transaction tokens associated with the request and denial may be initiated and entered into the blockchain.

In another example, once the user 18 has gained access to the surveillance system 58, a user may attempt to add, modify, and/or delete data recorded by the video recorder 60. In response to the user 18 making a request to add, modify, and/or delete data recorded by the video recorder 60, the nodes 46 of the blockchain network 44 may receive the request and may be configured to determine whether the request is a valid request in view of the access rights provided to the user 18 and an associated user account 16 by the one or more smart contracts 62 associated therewith. In some cases, determining whether the request is valid may involve the nodes 46 of the blockchain network 44 determining if the request is valid based on the one or more smart contracts 62 associated with the requested data, the video recorder 60 that recorded the data, the user account 16, and the building management client 14 through which the user 18 may access the blockchain network 44. If a threshold number of nodes 46 indicate the request is valid, the request will be approved by the blockchain network 44 and one or more transaction tokens associated with the request and approval may be initiated and distributed to be entered into the blockchain to record the request. If the threshold number of nodes 46 do not indicate the request is valid, the request will be denied by the blockchain network 44 and one or more transaction tokens associated with the request and denial may be initiated and entered into the blockchain.

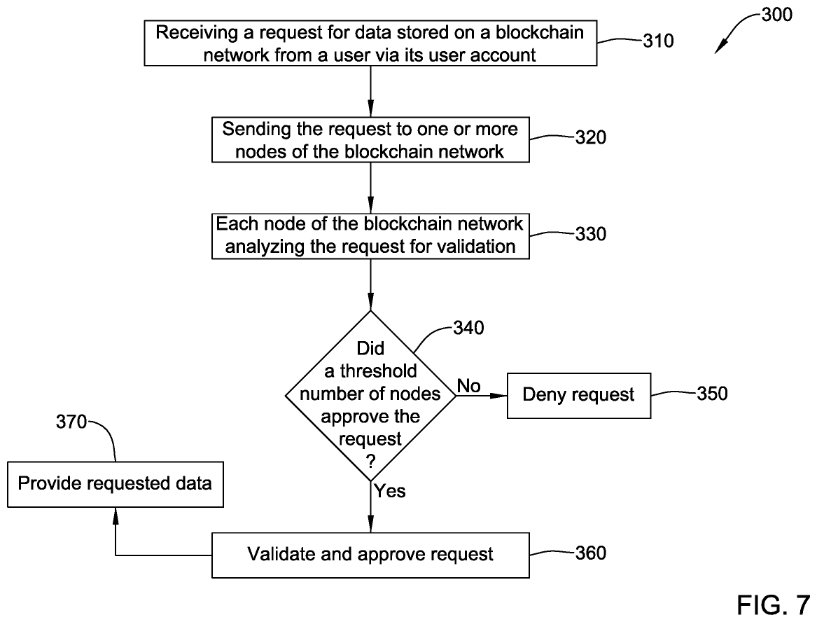

FIG. 7 depicts a schematic flow diagram of a method 300 of operating a blockchain network (e.g., the blockchain network 44 and/or one or more other suitable blockchain networks) of a building management system (e.g., the building management system 10, including, but not limited to, the surveillance system 58, and/or one or more other suitable building management systems), where the blockchain network may include one or more blockchain nodes (e.g., the blockchain nodes 46, including, but are not limited to, components of the building automation system, and/or other suitable blockchain nodes). Once a user (e.g., the user 18 and/or one or more other suitable users) has gained access to the blockchain network (e.g., by entering credentials or other suitable information, as discussed above), a user may attempt to access data (e.g., view, modify, update, add, and/or delete data) on the blockchain network (e.g., when the blockchain network is formed from a surveillance system, the data may include data being recorded by the video recorder 60 and/or data previously recorded by the video recorder 60) and the blockchain network may receive 310 a request for data on the blockchain network from the user. The received request may include a request for data from a particular component or device of the building automation system.

In response to the user making a request (e.g., a transaction request) for access to data on the blockchain network and/or the blockchain network receiving the request for access to data, a node of the blockchain network that receives the data request, may distribute or send 320 the request (e.g., via a transaction token that the node assigns to and/or for the request and that is to be added to the blockchain) to one or more nodes on the blockchain network for verification of the request, which may include a verification that a user account from which the request is made is part of the blockchain network, the component that captured the data requested is part of the blockchain network, and the user account is allowed the requested access. In some cases, the node receiving the request may, by default, send the request to each node of the blockchain network or send the request to a predetermined set of nodes of the blockchain network. Further, in some case, the number of nodes and/or which nodes that are to be sent the request may be determined based on a type of a request. In one example, more nodes and/or different nodes may be sent a request for permission to access and delete data from the building management system (e.g., the surveillance system and/or other suitable building management systems) than the number and/or types of nodes that may receive a read/view-only request.

Each node of the blockchain network that receives the request and is capable of analyzing the request may analyze 330 the request for validation. In some cases, the nodes may analyze a request for data on the blockchain network by comparing the request to a smart contract (e.g., the smart contract(s) 62 and/or other suitable smart contracts) associated with the user and/or user account making the request for data. The associated smart contract may be identified from information in the blockchain. Additionally, the nodes may analyze the request to confirm the user account from which the request originated and the data recorder that captured the requested data are part of the blockchain network. If the request for data is allowed in view of data access permissions of the smart contract and/or the user account and data recorder being part of the blockchain network, the node analyzing the request may respond to the node from which the request is sent and/or other suitable nodes by indicating the request is valid. If the request for data is not allowed in view of the data access permissions of the smart contract and/or the user account or the data recorder are not part of the blockchain network, the node analyzing the request may respond to the node from which the request is and/or other suitable nodes by indicating the request is invalid

After the node sends the request by the user for access to data on the blockchain network (e.g., of the building management system), the node that sent the request and/or other suitable node(s) determines 340 whether a threshold number of nodes approved and/or validated the request. Alternatively or additionally, the node that sent the request and/or other suitable node(s) determines 340 whether a threshold number of nodes disapproved of the request and/or indicated the request is invalid.

If the node that sent the request and/or other suitable node(s) determine that the threshold number of nodes have not approved and/or validated the request and/or a threshold number of nodes have disapproved the request or indicated the request is invalid, the node sensing the request and/or other suitable node(s) may deny 350 the request. In some cases, the blockchain network may take no action when a request is denied. Alternatively, the blockchain network may provide one or more indications (e.g., alarms, a light, indications on a user interface, text messages, emails to a manager, etc.) indicating a request for access was denied, the user requesting access, the access requested, a time at which access requested, a location from where access was requested, and/or other suitable information. In some cases, the blockchain network (e.g., the blockchain node from which the request originated) may distribute such information to all blockchain nodes storing the blockchain in order to add a block containing the request information and/or result of the request to the blockchain.

If the node that sent the request and/or other suitable node(s) determine that the threshold number of nodes have approved and/or validated the request, the node sensing the request and/or other suitable node(s) may validate and/or approve 360 the request. In some cases, the blockchain network may take no action other than to provide 370 the requested access and/or data when a request is validated and/or approved. Alternatively, the blockchain network may provide one or more indications (e.g., alarms, lights, indications on a user interface, text messages, emails to a manager, etc.) indicating a request for access was validated and/or approved, the user requesting access, the access requested, a time at which access requested, a location from where access was requested, and/or other suitable information. In some cases, the blockchain network (e.g., the blockchain node from which the request originated) may distribute such information to all blockchain nodes storing the blockchain in order to add a block containing the request information and/or result of the request to the blockchain.

Those skilled in the art will recognize that the present disclosure may be manifested in a variety of forms other than the specific embodiments described and contemplated herein. Accordingly, departure in form and detail may be made without departing from the scope and spirit of the present disclosure as described in the appended claims.

1. A building management system comprising:
one or more building management devices;
one or more building management clients configured to be used by a user to access the one or more building management devices; and
wherein at least one of the one or more building management devices and at least one of the one or more building management clients are each a blockchain node of a blockchain network for the building management system.

2. The building management system of claim 1, further comprising:
one or more user accounts associated with users of the building management system; and
wherein at least one of the one or more user accounts is a blockchain node of the blockchain network.

3. The building management system of claim 1, wherein the one or more building management devices include devices of a video surveillance system.

4. The building management system of claim 1, wherein the one or more building management clients include one or more of a thick client, a web client, and a mobile application.

5. The building management system of claim 1, wherein each transaction between blockchain nodes is assigned a transaction token that is sent and saved to each blockchain node of the blockchain network.

6. The building management system of claim 5, wherein the transaction token comprises a cryptographic signature.

7. The building management system of claim 1, wherein data produced by a building management device of the one or more building management devices is assigned a transaction token by the building management device and the transaction token is sent to and saved at each blockchain node of the blockchain network.

8. The building management system of claim 1, wherein when a blockchain node receives a user initiated transaction request, the blockchain node that receives the user initiated transaction request sends a transaction token that corresponds to the user initiated transaction request to all other blockchain nodes for approval.

9. The building management system of claim 8, wherein when a threshold value of blockchain nodes have approved the user initiated transaction request, the blockchain node that received the user initiated transaction request allows the transaction.

10. The building management system of claim 9, wherein the threshold value of blockchain nodes is less than one hundred percent (100%) of the blockchain nodes of the blockchain network.

11. The building management system of claim 8, wherein the user initiated transaction request includes one or more of adding data to one or more building management devices, deleting data from one or more building management devices, and updating data of one or more building management devices.

12. A surveillance system comprising:
a video recorder;
a storage device in communication with the video recorder to receive and store data from the video recorder;
wherein the video recorder and the storage device are blockchain nodes in a private blockchain network for the surveillance system.

13. The surveillance system of claim 12, further comprising:
a user account of a user of the surveillance system; and
wherein the user account is a blockchain node in the private blockchain network.

14. The surveillance system of claim 13, wherein the video recorder assigns a cryptographic signature to data that the video recorder produces, sends the data that the video recorder produces to the storage device, and sends the cryptographic signature to all of the blockchain nodes in the private blockchain network.

15. The surveillance system of claim 13, wherein when the user requests access, via the user account, to data produced by the video recorder saved on the storage device, a transaction token that corresponds to the user request is sent to all blockchain nodes of the private blockchain network to validate the user request before allowing access to the data produced by the video recorder.

16. The surveillance system of claim 12, further comprising:
a client; and
a user account of a user of the surveillance system, the user accesses the user account via the client; and
wherein at least one of the client and the user account are blockchain nodes in the private blockchain network.

17. A method of operating a blockchain network of a building management system, wherein the blockchain network comprises a plurality of blockchain nodes, the method comprising:
recording data at a data recorder, the data recorder is a first blockchain node of the blockchain network;
assigning a cryptographic signature to the data recorded at the data recorder; and
sending the cryptographic signature assigned to the data recorded at the data recorder to each blockchain node of the blockchain network.

18. The method of claim 17, wherein at least one blockchain node of the blockchain network corresponds to a user account of a user of the building management system.

19. The method of claim 18, further comprising:
receiving a request from the user via the user account to access the data recorded at the data recorder;
in response to receiving the request from the user, the request is sent to each blockchain node of the blockchain network to validate the user account and the data recorder as being blockchain nodes in the blockchain network.

20. The method of claim 19, wherein
when a threshold amount of blockchain nodes in the blockchain network have validated the user account and the data recorder as being blockchain nodes in the blockchain network, the user is given access to data recorded at the data recorder; and
when the threshold amount of blockchain nodes in the blockchain network have not validated the user account and the data recorder as being blockchain nodes in the blockchain network, the user is denied access to data recorded at the data recorder.
